(19) United States
(12) Patent Application Publication
(10) Pub. No.: US 2015/0350463 A1
(43) Pub. Date: Dec. 3, 2015

(54) PHOTO PROCESSING KIOSK

(71) Applicant: Ryan Moore, West Henrietta, NY (US)

(72) Inventor: Ryan Moore, West Henrietta, NY (US)

(21) Appl. No.: 14/729,005

(22) Filed: Jun. 2, 2015

Related U.S. Application Data
(60) Provisional application No. 62/006,748, filed on Jun. 2, 2014.

(51) Int. Cl. H04N 1/00; G06F 3/0484; G06F 3/0482

(52) U.S. Cl. CPC H04N 1/00167; G06F 3/0482; G06F 3/04847; G06F 3/04845; G06F 3/04842; H04N 1/00175; H04N 1/00177; H04N 1/00188; H04N 1/00161; H04N 1/00413

(57) ABSTRACT

A photo processing kiosk displays a catalog of photo enhancement items. In response to a user selection of a first photo enhancement item, detailed information of the first photo enhancement item is displayed, including a first button to associate a photo from the user with the first photo enhancement item. In response to an activation of the first button, a user agreement is displayed and the user is prompted to accept terms of the user agreement in order to acquire the first photo enhancement item. A signal is received via a second button displayed with the user agreement indicating an acceptance of the user agreement. In response to the signal indicating a user acceptance of the user agreement, a photo processing operation is performed on an image received from the user by integrating the image with the first photo enhancement item, generating a photo enhancement product.

### RELATED APPLICATIONS

This application claims the benefit of U.S. Provisional Patent Application No. 62/006,748, filed Jun. 2, 2014, which is incorporate by reference herein in its entirety.

### FIELD OF THE INVENTION

Embodiments of the present invention relate generally to photo processing. More particularly, embodiments of the invention relate to user interface of a photo processing kiosk.

### BACKGROUND

An electronic kiosk (or computer kiosk or interactive kiosk) houses a computer terminal that often employs custom kiosk software designed to function while preventing users from accessing system functions. Computerized kiosks may store data locally, or retrieve it from a computer network. Some computer kiosks provide a free, informational public service, while others serve a commercial purpose (see mall kiosk). Touchscreens, trackballs, computer keyboards, and pushbuttons are all typical input devices for interactive computer kiosk. Touchscreen kiosks are commercially used as industrial appliances, reducing lines, eliminating paper, improving efficiency and service. Their uses are unlimited from refrigerators to airports, health clubs, movie theaters and libraries.

One type of electronic kiosk is a photo processing kiosk that contains hardware or software for creating image content. A consumer can, for example, place a picture in the kiosk, have the picture digitized to a digital image, edit the digital image and print the edited image on various forms of paper output. Some photo processing kiosks provide pre-designed templates into which a consumer can place his own pictures. Some photo processing kiosks contain a scanner unit for converting a picture to a digital image.

Before allowing a consumer accessing the functionalities of a photo processing kiosk, a conventional kiosk requires the consumer to agree licensing or access terms set forth by the kiosk provider and upload the consumer's photos to be processed. Such a requirement sometimes may lead to less desirable user or marketing experience.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating a system configuration for importing medical device data for storage according to one embodiment of the invention.

FIG. 2 is a block diagram illustrating an example of a photo processing kiosk according to one embodiment of the invention.

FIGS. 3A-3I are screenshots illustrating examples of graphical user interface of photo processing software running within a photo processing kiosk according to certain embodiments of the invention.

FIG. 4 is a flow diagram illustrating a process of operating a photo processing kiosk according to one embodiment of the invention.

FIG. 5 is a flow diagram illustrating a process of operating a photo processing kiosk according to another embodiment of the invention.

FIG. 6 is a block diagram illustrating an example of a data processing system which may be used with one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some embodiments, a user friendly user interface and convenient functionalities are provided at a photo processing kiosk. A user or consumer can access at least some portions of functionalities of the photo processing kiosk without having to upload pictures of the consumer to be processed or agree to access terms of accessing the photo processing kiosk. In one embodiment, a user can browse via a user interface certain catalogs of services and products provided by the photo processing kiosk before deciding whether to employ the services of the photo processing kiosk for processing user's photos. The user can browse and select one or more products and/or services from the user interface without having to uploading its photos to the photo processing kiosk.

In this way, the user can feel more comfortable to browse around and discover any functionalities or services provided by the photo processing kiosk without the fear of unnecessarily exposing its photos, which may leads to more business for the corresponding photo processing kiosk provider. Once the user decides to use a product and/or service of the photo processing kiosk, the user is then prompted to upload its photos to be processed. The user may also be required by agree to certain access terms of using the photo processing kiosk prior to uploading its photos. In one embodiment, once the user agrees to the access terms, he/she may be able to access more functionalities, products, and/or services that were not available prior to agreeing to the access terms.

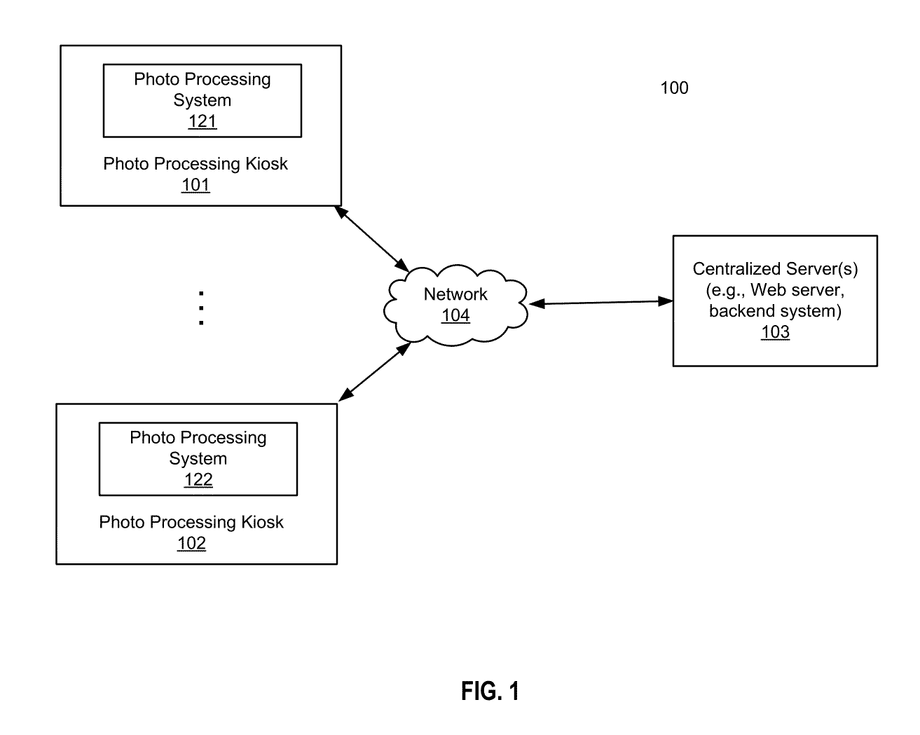

FIG. 1 is a block diagram illustrating a photo processing kiosk system configuration according to one embodiment of the invention. Referring to FIG. 1, system 100 include multiple photo processing kiosks 101-102 communicatively coupled to a centralized server associated with a photo processing kiosk provider over network 104. Network 104 may be any kinds of network, such as a local area network (LAN), a wide area network (e.g., Internet), or a combination both, wired or wireless. Photo processing kiosks 101-102 may be geographically at various locations, such as, shopping malls or retail stores. Each of photo processing kiosks 101-102 may be hosted by a computing device having components and/or functionalities similar to those available at a typical computer. Server 103 is to provide centralized management functions to photo processing kiosks 101-102, such as, for example, software maintenance or upgrades, commercial transactions (e.g., credit card transactions), etc.

Each of photo processing kiosks 101-102 includes a photo processing system (such as photo processing systems 121-122 respectively). For example, photo processing systems 121-122 may be implemented as photo processing software executed by a processor of photo processing kiosks 101-102, respectively. The photo processing systems 121-122 may be downloaded, installed, and/or upgraded from centralized system 103 over network 104. The photo processing systems 121-122 may be configured to provide various photo processing services and/or products, such as, for example, photo scanning, importing, editing or enhancement, printing, conversion, etc.

According to one embodiment, a user friendly user interface and convenient functionalities are provided at each of photo processing kiosks 101-102. A user can access at least some portions of functionalities of photo processing systems 121-122 of the photo processing kiosks 101-102 without having to upload pictures of the user to be processed or agree to access terms of accessing the photo processing kiosk. In one embodiment, a user can browse via a user interface certain catalogs of services and products provided by the photo processing kiosk before deciding whether to employ the services of the photo processing kiosk for processing user's photos. The user can browse and select one or more products and/or services from the user interface without having to uploading its photos to the photo processing kiosk. A user can evaluate each of the services provided, such as, for example, the cost of purchasing any of the products before having to commit further operations. Once the user decides to use a product and/or service of the photo processing kiosk, the user is then prompted to upload its photos to be processed. The user may also be required by agree to certain access terms of using the photo processing kiosk prior to uploading its photos. In one embodiment, once a user agrees to the access terms, the user may be able to access more functionalities, products, and/or services that were not available prior to agreeing to the access terms.

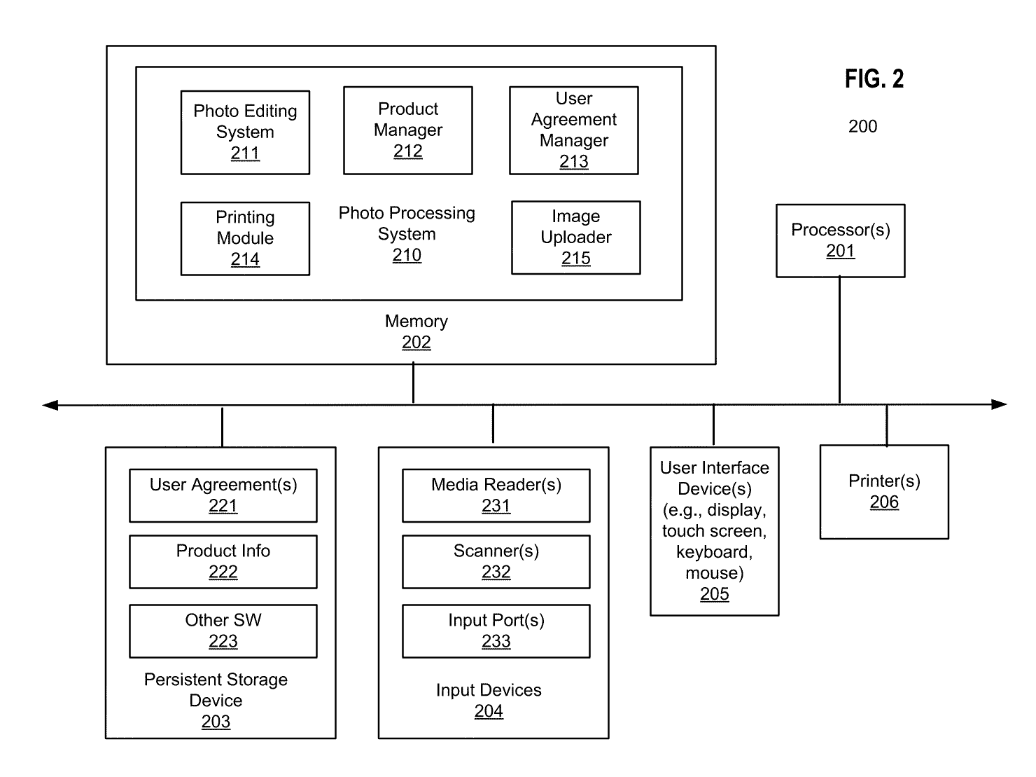

FIG. 2 is a block diagram illustrating an example of a photo processing kiosk according to one embodiment of the invention. Photo processing kiosk 200 (also simply referred to as a photo kiosk or kiosk) may represent any of photo processing kiosks 101-102 of FIG. 1. Referring to FIG. 2, kiosk 200 includes, but is not limited to, photo processing system 210 loaded and hosted by an operating system in memory 202 and executed by one or more processors 201. Photo processing system 210 may be photo processing software that is installed and stored in persistent storage device 203 as part of software 223. Memory 202 may be any kind of volatile memory devices such as random access memory (RAM) devices. Persistent storage device 203 may be any kind of non-volatile storage devices such as hard disks or flash memory devices. An operating system hosting photo processing system 210 can be any kind of operating systems, such as, for example, Windows operating system from Microsoft, OS X or iOS from Apple Inc., Android operating system from Google, or other operating systems (e.g., LINUX, UNIX).

Kiosk 200 further includes various input devices 204 to allow a user to import a photo to be processed by photo processing system 210. Input devices 204 include a media card reader 231, scanner 232, and one or more input ports 234. Media card reader 231 is capable of reading from a variety of media memory cards. Scanner may be a flat-bed scanner configured to scan a hardcopy of a photo into a digital photo. Input ports 233 may include a universal serial bus (USB) port. Input devices 204 may further include a wireless interface device, such as a WiFi, Bluetooth, near field communications (NFC), to receive or accept photos from a user device over a wireless communication media.

Kiosk 200 may further include one or more user interface devices 205 to allow a user to interact with photo processing system 210 via a graphical user interface (GUI) provided by photo processing system 210 (not shown). Kiosk 200 may further include a network interface device (not shown) configured to couple kiosk 200 to a network, such as network 104 of FIG. 1. Kiosk 200 may further include or be coupled to a printer 206 to allow a user to print out an enhanced photo product or item produced by photo processing system 210.

A user would typically input his or her images into kiosk 200 via user interface device 205, enter user-identification information (such as name, address, telephone number, e-mail address, and/or credit card information) into kiosk 200, and then order products and/or services based on the images (such as prints, slides, enlargements, photo-CDROMs, e-mailed images, etc.). Kiosk 200 is typically located in a retail store, shopping mall, or other location to make customer access easy and convenient. Some embodiments include a drive-up-window so customers can perform transactions from their car. Typically, information for users is stored, and then uploaded periodically to a central repository and image-processing facility, such as server 103 of FIG. 1. That central image-processing facility makes the products or performs the services ordered, and delivers the result to the customer, e.g., by mail. In some embodiments, kiosk 200 is a standalone device on which a user can operate without operator assistance.

In one embodiment, photo processing system 210 includes, but is not limited to, photo editing system 211, product manager 212, user agreement manager 213, image uploader 215, and printing module 216. Product manager 212 (also referred to as an item manager) is to manage photo enhancement products (also referred to as photo enhancement items), which may be stored and retrieved from persistent storage device 203 as part of product information 222. Product information 222 may be periodically updated from a centralized facility over a network. Product manager 212 may also operate as a workflow manager to organize and manage the photo processing workflow and interact with a user.

Kiosk 200 further provide photo editing services to users, which may be handled by photo editing module 211. User agreement manager 213 is to manage user agreements, which may be stored in persistent storage device 203 as part of user agreements 221, and present the same to a user via a graphical user interface. Image uploader or upload module 215 is to read a media device inserted into any of input devices 204 to import images from a user. Printing module 214 is to print out the enhanced photo products or items selected and edited by the user.

In one embodiment, when a user initiates operating kiosk 200, for example, by touching a touch screen of kiosk 200, product manager 212 presents a catalog of photo enhance products to the user via a graphical user interface. Product manager 212 interacts with the user via the graphical user interface to allow the user to browse any one of the presented photo enhancement products without requiring the user to commit anything, such as accepting a user agreement or licensing agreement, or uploading user's images, etc.

A user can browse via a user interface certain catalogs of services and products provided by product manager 212 before deciding whether to acquire the photo processing services to enhance the user's images. The user can browse and select one or more products and/or services from the user interface without having to uploading its photos to the photo processing kiosk. Once the user decides to acquire or purchase a photo enhancement product or item, the user can activate or click a button to add a user's image to be associated or integrated with a photo enhancement product (e.g., photo editing, integration with a greeting card, a photo gift) selected by the user.

In response to the activation of adding an image, according to one embodiment, product manager 212 invokes user agreement manager 213 to retrieve an appropriate user agreement from user agreements 221 stored in persistent storage device 203 and to present the user agreement to the user via the graphical user interface. The user is requested to accept one or more access terms or usage terms described in the user agreement, which may be copyright agreement. If the user does not accept any of the terms in the user agreement, the user is denied to acquire the selected photo enhancement product or any other products. Note that the user agreement is presented to the user only after the user has decided or committed to acquire or purchase a photo enhancement product, for example, by clicking an “add photo” or “upload photo” button. Prior to the activation of the button, the user is free to navigate the products presented by product manager 212.

Once the user has accepted the terms of the user agreement, for example, by clicking an “accept” button displayed with the user agreement, according to one embodiment, product manager 212 displays a message on a display device to request the user to import or upload one or more images to be integrated or enhanced with the selected photo enhancement product or products. One or more image upload options may be presented to allow the user to upload the images. The upload options may include uploading images from an external storage device (e.g., flash drive) via a USB port, a scanner, or from a mobile device via a wireless connection (e.g., WiFi, Bluetooth, and NFC). Note that the user is requested to upload his/her images only after the user has accepted the terms of the user agreement. The images may be read and uploaded by image uploader 215 and may also be temporarily stored in persistent storage device 203.

Once the images have been uploaded or imported into the system, the user can utilize photo editing function of kiosk 200 to edit the images, which may be handled by photo editing module 211. The enhanced photo products can then be printed via printing module 214 into hard copies. Alternatively, they can be transmitted (e.g., email) to a destination specified the user.

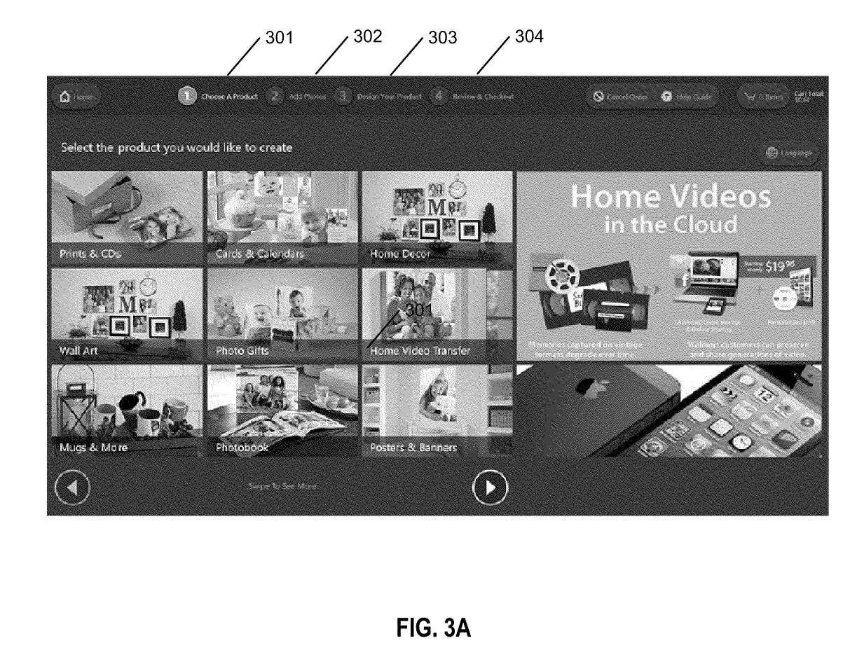

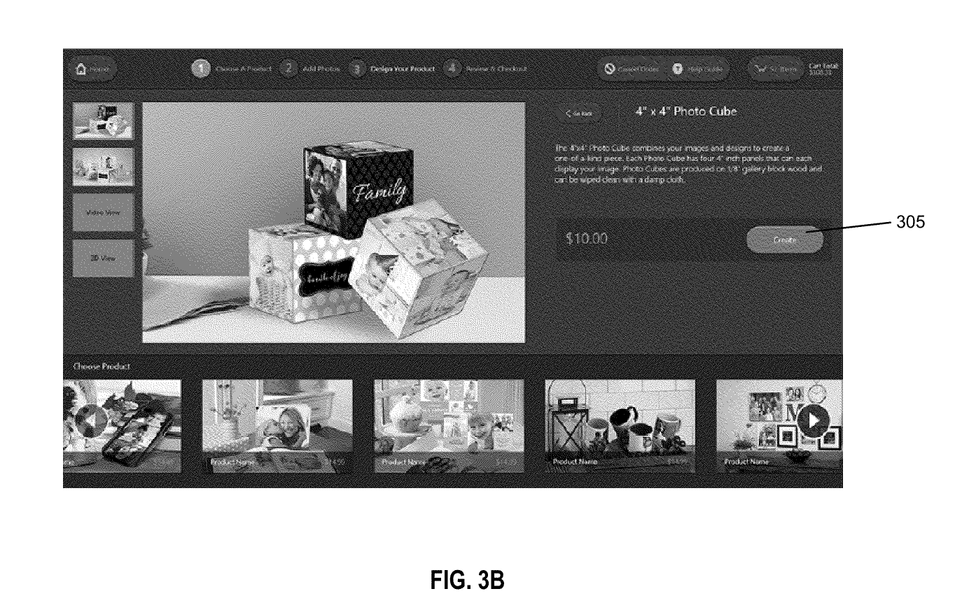

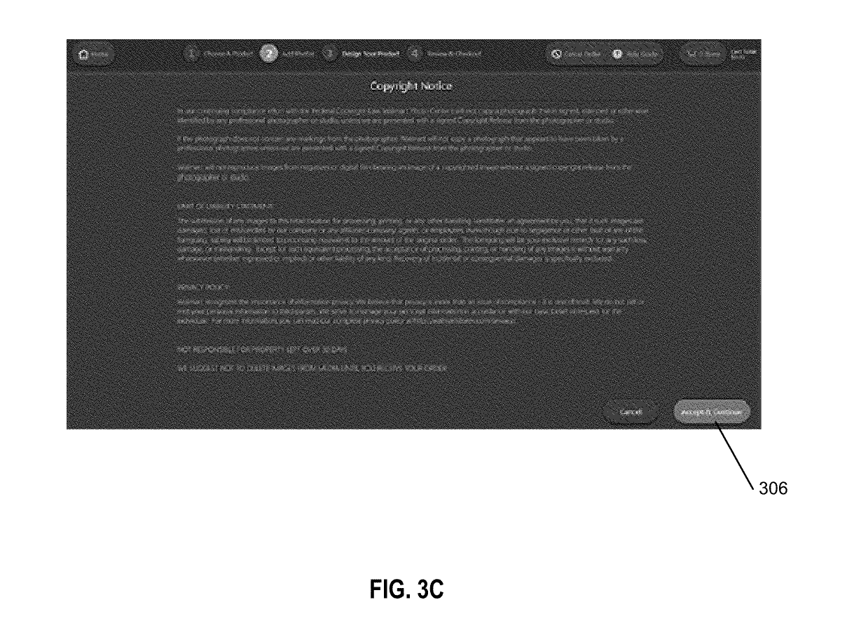

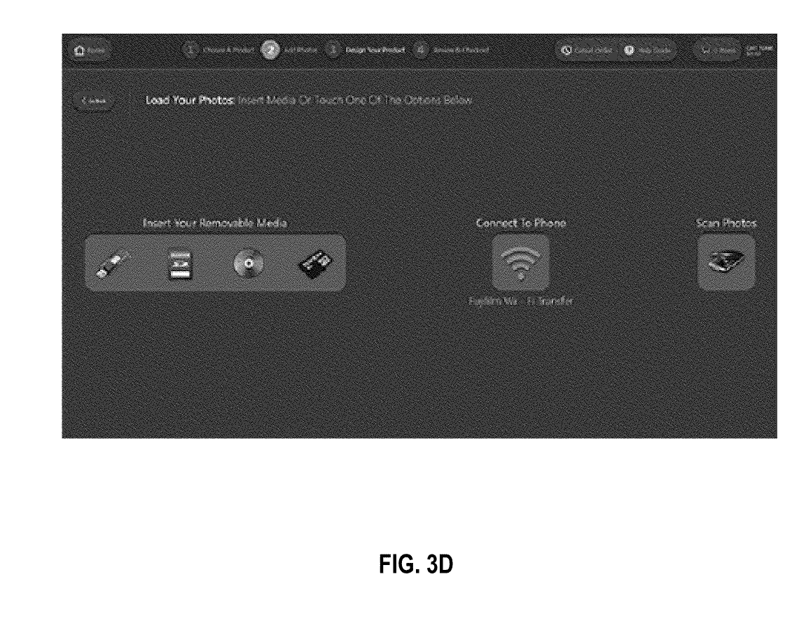

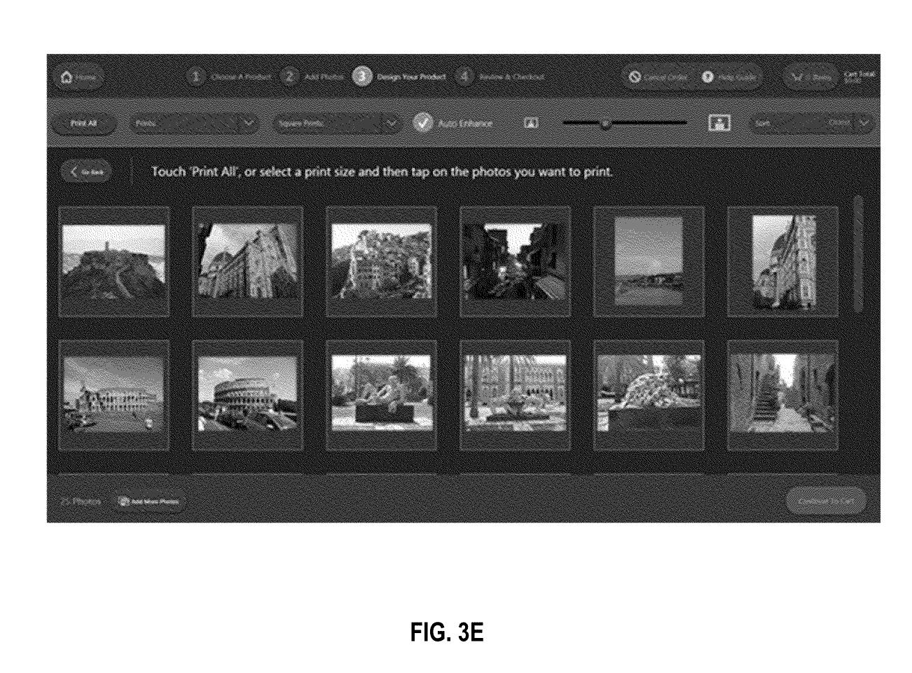

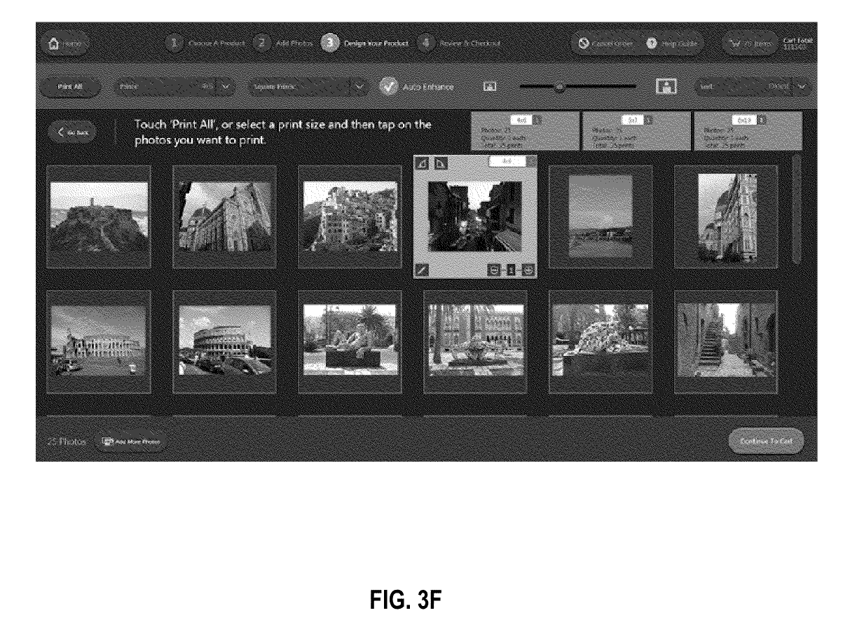

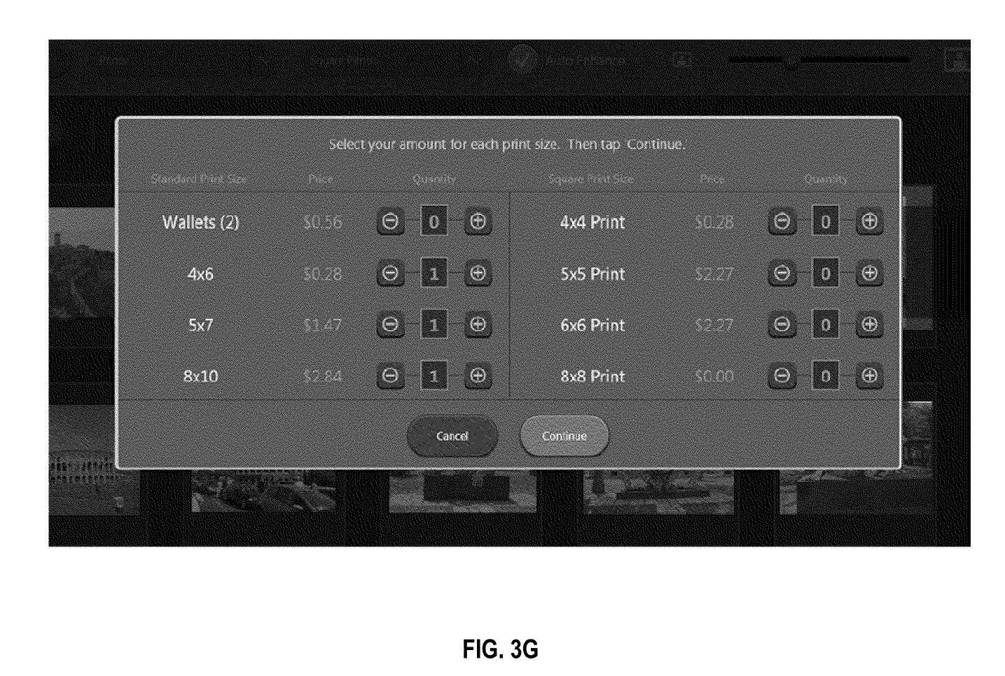

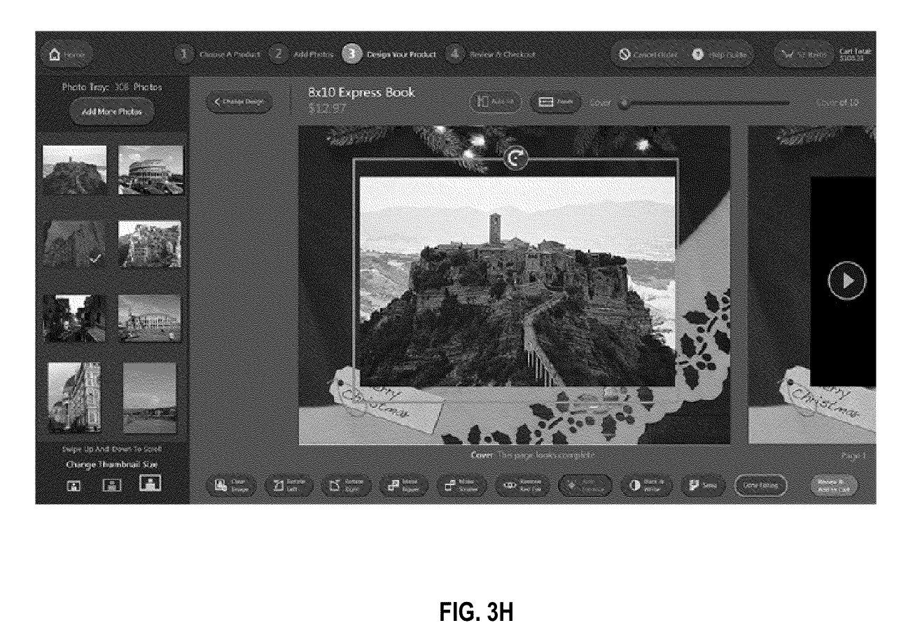

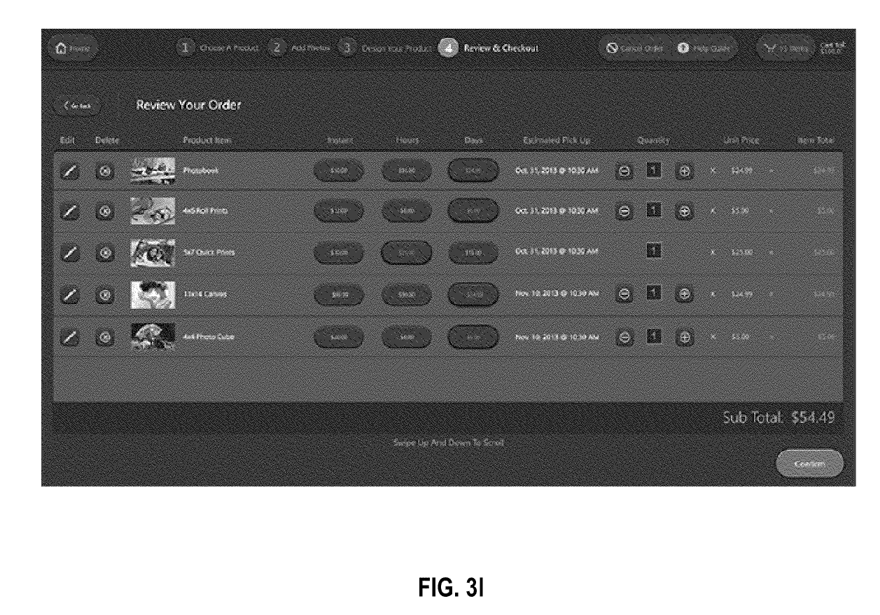

FIGS. 3A-3I are screenshots illustrating examples of graphical user interface of photo processing system running within a photo processing kiosk according to certain embodiments of the invention. The graphical user interface (GUI) pages as shown in FIGS. 3A-3I may be presented by any of photo processing kiosk 200 of FIG. 2. Typically, the photo processing software running at a photo processing kiosk is idle and displays a blank or a screen savor if there is no user interaction with the photo processing kiosk (e.g., touch screen or keyboard) for a preconfigured period of time. When a user interacts with the photo processing kiosk, for example, by touching a display screen or key of the photo processing kiosk, a GUI page having a list of products and/or services provided by the photo processing kiosk is displayed as shown in FIG. 3A.

Referring to FIG. 3A, the GUI as shown lists a catalog of various photo enhancement products and/or services (also referred to as photo enhancement items) available at the photo processing kiosk, which may be presented by photo processing system 210 of FIG. 2. In one embodiment, the photo processing workflow includes multiple workflow stages, including choose product stage 301, add photo stage 302, design stage 303, and review and checkout stage 304. FIG. 3A represents the choose product stage. In this stage, the catalog may include categories of printing, cards, home decoration, wall art, photo gifts, home video transfer, etc. This catalog is displayed without requiring the user to agree to an access term of a user agreement or upload photos to be processed. That is, the user does not have to commit anything in order to browse and select the displayed products and/or services. A conventional photo processing kiosk would require the user to agree to an access term or upload the photos to be processed, even before the user decides whether to use the products or services of the photo processing kiosk.

From the GUI page as shown in FIG. 3A, the user can select any one of the displayed products to create a user end product that is eventually made and printed. The user can further examine the details of each of the listed product as shown in FIG. 3B. The detailed information of the selected product includes the estimated cost of acquiring or purchasing the selected product. In this stage, a user can simply browse and evaluate various products with cost in mind without having to commit anything, such as accepting a user agreement or upload user's images, etc.

Once the user decides to make a user end product using the tools or services provided by the photo processing kiosk, such as, for example, by clicking create button 305, the user can add or import its photos to be processed. In response to the request to add photos, the photo processing kiosk then displays an access terms of a user agreement, in this example, a copyright notice, to require the user to agree, as shown in FIG. 3C. In this example, the user is not required agree anything until the user decides to create an enhanced photo product, for example, by clicking create button 305 of FIG. 3B.

Once the user agrees the terms, for example, by clicking accept button 306 of FIG. 3C, a photo upload GUI page is displayed to allow the user to upload the photos to be processed as shown in FIG. 3D, which is now in add photo stage 302. Referring to FIG. 3D, the user can upload its photos from various options, such as, for example, from a storage media device (e.g., thumb drive, memory card, CD), from an external mobile device using a wireless protocol (e.g., Bluetooth, near field communications (NFC), infrared), or the user can scan a physical photo using a scanner associated with the kiosk. In one embodiment, the photo processing kiosk may further includes one or more plugins integrated therein to communicate with and access various external or third-party devices or services. For example, the photo processing kiosk may invoke a photo processing tools that is available from an external mobile device of the user via a wireless connection.

Once the user's photos have been uploaded, the uploaded images may be displayed in thumbnails as shown in FIG. 3E, which is now in design stage 303. The user can further manipulate or design around using the corresponding tools available at the photo processing kiosk as shown in FIG. 3F. The available tools may include photo editing and enhancement, incorporating a photo with a template or design scene, etc. The user can individually select one of the uploaded photos for printing. Alternatively, the user can print all of the photos as a batch as shown in FIG. 3G. Furthermore, the user can create a product (e.g., card) having a particular photo therein as shown in FIG. 3H. Once all of the designs and manipulations have completed, as shown in FIG. 3I, which is now in review and checkout stage 304, the user can order the designed products from the kiosk.

According to one embodiment, a photo processing kiosk can further provide media digitized service. For example, a user can bring a rental movie DVD and have a photo processing kiosk to make a digital copy. In response, the photo processing kiosk can communicate with a backend system (e.g., backend system 103 to obtain a valid digital license and generate a legal digital copy of the DVD for a fraction of the cost for obtaining another physical copy of the DVD.

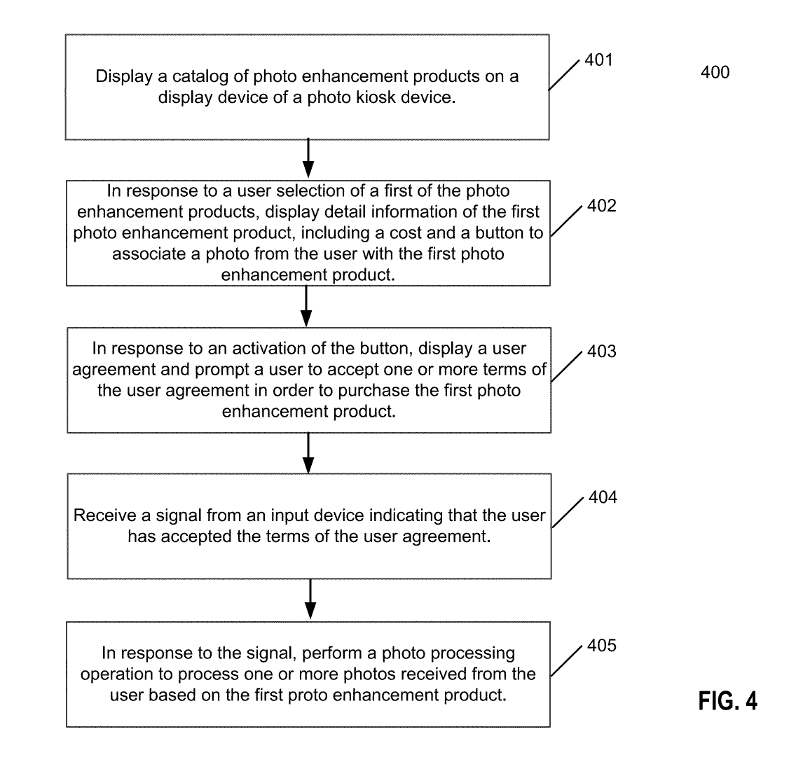

FIG. 4 is a flow diagram illustrating a process of photo processing operations according to one embodiment of the invention. Process 400 may be performed by processing logic that includes hardware (e.g. circuitry, dedicated logic, etc.), software (e.g., embodied on a non-transitory computer readable medium), or a combination thereof. For example, process 400 may be performed by photo processing system 210 of FIG. 2. Referring to FIG. 4, at block 401, processing logic displays a catalog of photo enhancement products or items on a display device of a photo processing kiosk. In response to a user selection of a first of the photo enhancement products, at block 402, processing logic displays the detailed information of the first photo enhancement product, including an estimated cost and a button to associate a photo from the user with the first photo enhancement product (e.g., “add photo” button). In response to an activation of the button, at block 403, processing logic displays a user agreement and prompts the user to accept one or more terms of the user agreement in order to acquire or purchase the first photo enhancement product. At block 404, processing logic receives a signal from an input device indicating that the user has accepted the terms of the user agreement, for example, by clicking an accept button displayed along the user agreement. At block 405, in response to the signal, processing logic performs a photo processing operation to process one or more photos received from the user based on the first photo enhancement product.

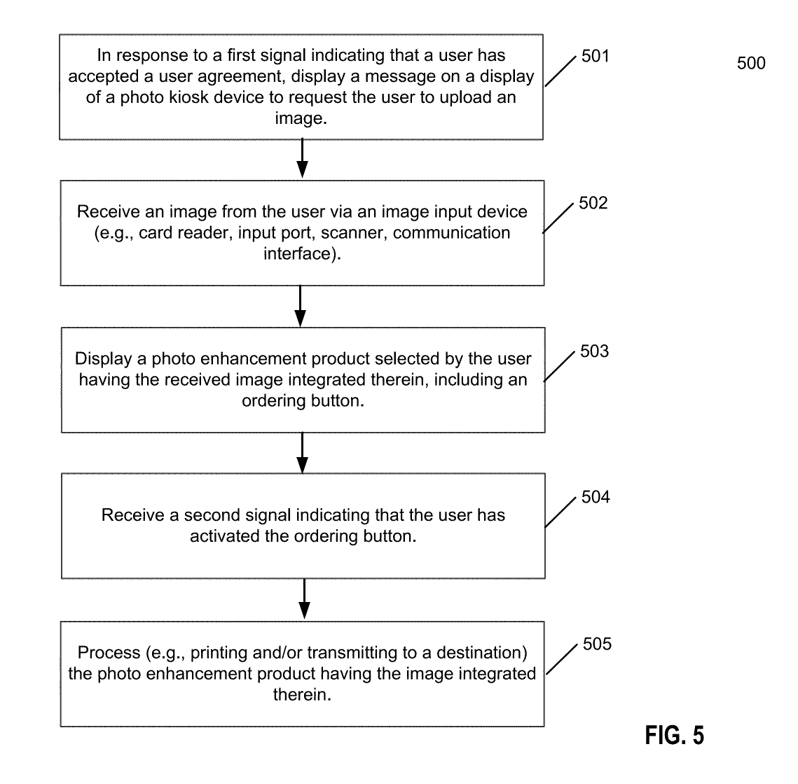

FIG. 5 is a flow diagram illustrating a process of photo processing operations according to another embodiment of the invention. Process 500 may be performed by processing logic that includes hardware (e.g. circuitry, dedicated logic, etc.), software (e.g., embodied on a non-transitory computer readable medium), or a combination thereof. For example, process 500 may be performed as part of operations involved in block 405 of FIG. 4. Referring to FIG. 5, at block 501, in response to a first signal indicating that a user has accepted the terms of a user agreement, processing logic displays a message on a display device of a photo processing kiosk to request the user to upload an image or images to be processed. At block 502, processing logic receives an image or images from the user via an image input device (e.g., card reader, USB port, scanner, wireless interface). At block 503, processing logic displays a photo enhancement product selected by the user having the received image or images integrated therein, including an ordering or checkout button. At block 504, processing logic receives a second signal indicating that the user has activated the ordering or checkout button. At block 505, processing logic processes (e.g., printing and/or transmitting the finished product to a destination specified by the user) the photo enhancement product having the image or images integrated therein.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

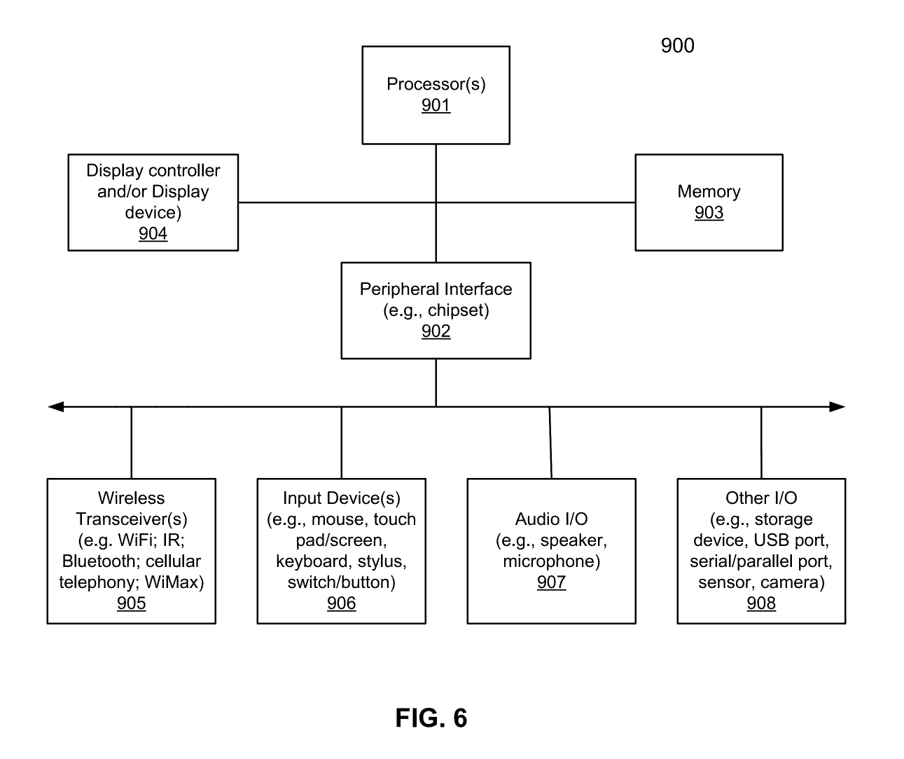

FIG. 6 is a block diagram illustrating an example of a data processing system which may be used with one embodiment of the invention. For example, system 900 may represents any of data processing systems described above performing any of the processes or methods described above, such as, for example, photo processing kiosks 101-102 and backend system 103 of FIG. 1. System 900 may represent a server or a client such as a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof.

Referring to FIG. 3, in one embodiment, system 900 includes processor 901 and peripheral interface 902, also referred to herein as a chipset, to couple various components to processor 901 including memory 903 and devices 905-908 via a bus or an interconnect. Processor 901 may represent a single processor or multiple processors with a single processor core or multiple processor cores included therein. Processor 901 may represent one or more general-purpose processors such as a microprocessor, a central processing unit (CPU), or the like. More particularly, processor 901 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 901 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 901 is configured to execute instructions for performing the operations and steps discussed herein.

Peripheral interface 902 may include memory control hub (MCH) and input output control hub (ICH). Peripheral interface 902 may include a memory controller (not shown) that communicates with a memory 903. Peripheral interface 902 may also include a graphics interface that communicates with graphics subsystem 904, which may include a display controller and/or a display device. Peripheral interface 902 may communicate with graphics device 904 via an accelerated graphics port (AGP), a peripheral component interconnect (PCI) express bus, or other types of interconnects.

An MCH is sometimes referred to as a Northbridge and an ICH is sometimes referred to as a Southbridge. As used herein, the terms MCH, ICH, Northbridge and Southbridge are intended to be interpreted broadly to cover various chips who functions include passing interrupt signals toward a processor. In some embodiments, the MCH may be integrated with processor 901. In such a configuration, peripheral interface 902 operates as an interface chip performing some functions of the MCH and ICH. Furthermore, a graphics accelerator may be integrated within the MCH or processor 901.

Memory 903 may include one or more volatile storage (or memory) devices such as random access memory (RAM), dynamic RAM (DRAM), synchronous DRAM (SDRAM), static RAM (SRAM), or other types of storage devices. Memory 903 may store information including sequences of instructions that are executed by processor 901, or any other device. For example, executable code and/or data of a variety of operating systems, device drivers, firmware (e.g., input output basic system or BIOS), and/or applications can be loaded in memory 903 and executed by processor 901. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 902 may provide an interface to IO devices such as devices 905-908, including wireless transceiver(s) 905, input device(s) 906, audio IO device(s) 907, and other IO devices 908. Wireless transceiver 905 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 906 may include a mouse, a touch pad, a touch sensitive screen (which may be integrated with display device 904), a pointer device such as a stylus, and/or a keyboard (e.g., physical keyboard or a virtual keyboard displayed as part of a touch sensitive screen). For example, input device 906 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 907 may include a speaker and/or a microphone to facilitate voice-enabled functions, such as voice recognition, voice replication, digital recording, and/or telephony functions. Other optional devices 908 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 908 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 3 illustrates various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A non-transitory machine-readable medium having instructions stored therein, which when executed by a processor, cause the processor to perform a method for processing photos via photo processing kiosks, the method comprising:
displaying, on a display device of a photo processing kiosk, a catalog of a plurality photo enhancement items to allow a user to select any of the photo enhancement items;
in response to a user selection of a first of the photo enhancement items, displaying detailed information of the first photo enhancement item, including displaying an estimated consideration of acquiring the first photo enhancement item and a first button to associate a photo from the user with the first photo enhancement item;
in response to an activation of the first button, displaying a user agreement and prompting the user to accept one or more terms of the user agreement in order to acquire the first photo enhancement item;
receiving a signal received from the user via a second button displayed with the user agreement indicating that the user has accepted the terms of the user agreement; and
in response to the signal indicating a user acceptance of the user agreement, performing a photo processing operation on an image received from the user by integrating the image with the first photo enhancement item, generating a photo enhancement product.

2. The non-transitory machine-readable medium of claim 1, wherein the photo processing operation is performed only after the user has accepted the user agreement.

3. The non-transitory machine-readable medium of claim 1, wherein the method further comprises:
in response to the signal indicating a user acceptance of the user agreement, displaying a message on the display device prompting the user to upload the image into the photo processing kiosk;
receiving the image from the user via an image input device associated with the photo processing kiosk;
displaying the first photo enhancement item having the image integrated therein, including displaying a second button to acquire the integrated photo enhancement item, wherein the photo processing operation is performed in response to an activation of the second button.

4. The non-transitory machine-readable medium of claim 3, wherein the image is uploaded into the photo processing kiosk only after the user has accepted the terms of the user agreement.

5. The non-transitory machine-readable medium of claim 3, wherein the method further comprises printing the integrated photo enhancement item via an image printer coupled to the photo processing kiosk.

6. The non-transitory machine-readable medium of claim 3, wherein the method further comprises transmitting a digital copy of the integrated photo enhancement item a destination specified by the user over a network.

7. The non-transitory machine-readable medium of claim 3, wherein the image input device comprises at least one of a universal serial bus (USB) device, a media card reader, a scanner, and a wireless interface device.

8. A computer-implemented method for processing photos via photo processing kiosks, the method comprising:
displaying, on a display device of a photo processing kiosk by an item manager executed by a processor of the photo processing kiosk, a catalog of a plurality photo enhancement items to allow a user to select any of the photo enhancement items;
in response to a user selection of a first of the photo enhancement items, displaying by the item manager detailed information of the first photo enhancement item, including displaying an estimated consideration of acquiring the first photo enhancement item and a first button to associate a photo from the user with the first photo enhancement item;
in response to an activation of the first button, displaying, by a user agreement manager executed by the processor, a user agreement and prompting the user to accept one or more terms of the user agreement in order to acquire the first photo enhancement item;
receiving a signal received from the user via a second button displayed with the user agreement indicating that the user has accepted the terms of the user agreement; and
in response to the signal indicating a user acceptance of the user agreement, performing a photo processing operation on an image received from the user by integrating the image with the first photo enhancement item, generating a photo enhancement product.

9. The method of claim 8, wherein the photo processing operation is performed only after the user has accepted the user agreement.

10. The method of claim 8, further comprising:
in response to the signal indicating a user acceptance of the user agreement, displaying a message on the display device prompting the user to upload the image into the photo processing kiosk;
receiving the image from the user via an image input device associated with the photo processing kiosk;
displaying the first photo enhancement item having the image integrated therein, including displaying a second button to acquire the integrated photo enhancement item, wherein the photo processing operation is performed in response to an activation of the second button.

11. The method of claim 10, wherein the image is uploaded into the photo processing kiosk only after the user has accepted the terms of the user agreement.

12. The method of claim 10, further comprising printing the integrated photo enhancement item via an image printer coupled to the photo processing kiosk.

13. The method of claim 10, further comprising transmitting a digital copy of the integrated photo enhancement item a destination specified by the user over a network.

14. The method of claim 10, wherein the image input device comprises at least one of a universal serial bus (USB) device, a media card reader, a scanner, and a wireless interface device.

15. A photo processing kiosks, comprising:
a display device;
a processor;
an item manager executed by the processor to display, on the display device, a catalog of a plurality photo enhancement items to allow a user to select any of the photo enhancement items, in response to a user selection of a first of the photo enhancement items, displaying detailed information of the first photo enhancement item, including displaying an estimated consideration of acquiring the first photo enhancement item and a first button to associate a photo from the user with the first photo enhancement item; and
a user agreement manager executed by the processor, in response to an activation of the first button, to display a user agreement and prompting the user to accept one or more terms of the user agreement in order to acquire the first photo enhancement item and to receive a signal received from the user via a second button displayed with the user agreement indicating that the user has accepted the terms of the user agreement, wherein in response to the signal indicating a user acceptance of the user agreement, the item manager is to perform a photo processing operation on an image received from the user by integrating the image with the first photo enhancement item, generating a photo enhancement product.

16. The photo processing kiosks of claim 15, wherein the photo processing operation is performed only after the user has accepted the user agreement.

17. The photo processing kiosks of claim 15, wherein the item manager is to
in response to the signal indicating a user acceptance of the user agreement, display a message on the display device prompting the user to upload the image into the photo processing kiosk,
receive the image from the user via an image input device associated with the photo processing kiosk, and
display the first photo enhancement item having the image integrated therein, including displaying a second button to acquire the integrated photo enhancement item, wherein the photo processing operation is performed in response to an activation of the second button.

18. The photo processing kiosks of claim 17, wherein the image is uploaded into the photo processing kiosk only after the user has accepted the terms of the user agreement.

19. The photo processing kiosks of claim 17, further comprising a printing module to print the integrated photo enhancement item via an image printer coupled to the photo processing kiosk.

20. The photo processing kiosks of claim 17, wherein a digital copy of the integrated photo enhancement item is transmitted a destination specified by the user over a network.

21. The photo processing kiosks of claim 17, wherein the image input device comprises at least one of a universal serial bus (USB) device, a media card reader, a scanner, and a wireless interface device.
